(19) United States
(12) Patent Application Publication
(10) Pub. No.: US 2011/0138081 A1
(43) Pub. Date: Jun. 9, 2011

(54) NETWORK-CONNECTED APPARATUS AND NETWORK CONNECTION METHOD

(75) Inventors: Yoshihide Matsuda, Chofu-shi (JP); Mamoru Sakai, Kawasaki-shi (JP); Norito Sugawara, Higashiyamato-shi (JP)

(73) Assignee: SEIKO EPSON CORPORATION, Tokyo (JP)

(21) Appl. No.: 12/962,573

(22) Filed: Dec. 7, 2010

(30) Foreign Application Priority Data
Dec. 9, 2009 (JP) 2009-279343

(51) Int. Cl. G06F 15/16

(52) U.S. Cl. 709/250

(57) ABSTRACT

A network-connected apparatus, which performs communication using an IP address via a network connected thereto and has a fixed first IP address having been set as an own IP address used for communication performed thereby, includes a detection section configured to detect that the network-connected apparatus has been connected to a network, an IP address acquisition section configured to, when it has been detected that the network-connected apparatus has been connected to a network, not perform communication using the first IP address, but acquire a second IP address, which is not used by any one of the other apparatuses existing on the network, by using an own MAC address thereof, and an IP address setting section configured to set the second IP address as the own IP address used for communication performed by the network-connected apparatus.

### BACKGROUND

1. Technical Field

The present invention relates to a network-connected apparatus that is connected to a network on which communication using an IP address is performed, and a network connection method thereof.

2. Related Art

Network-connected apparatuses, such as a personal computer (PC) and a printer which are connected to a network, perform communication on the network by using an own Internet Protocol (IP) address having been set thereon. For individual network-connected apparatuses, IP address setting is performed so that a fixed IP address is set by a user, an IP address, which has been acquired from a DHCP server connected to a network, is set, or the like.

For such a network-connected apparatus, there has been a problem, in which, for example, when a certain network-connected apparatus having a fixed IP address set thereon is connected to a different network, for example, in the case where an IP address the same as the fixed IP address is already used by any one of the other network-connected apparatuses existing on the different network, and owing thereto, the network-connected apparatus, in which the IP address is maintained as it is, cannot be used on the different network any more, it is necessary for users to recognize such a condition and perform a resetting operation of the IP address, and as a result, it takes a lot of trouble and time with the resetting operation.

Regarding this problem, a technology, which enables reduction of the lot of trouble with the resetting operation performed by users by, upon occurrence of a failure in which, when having been connected to a network, a network-connected apparatus fails in communication using an IP address, notifying the failure to a network manager and causing the network manager to automatically indicate a dialog, which enables the users to change the IP address, has been known to those skilled in the art (refer to JP-A-2006-128874).

According to the technology disclosed in JP-A-2006-128874, it is possible to reduce the lot of trouble with changing the IP address. However, in the technology disclosed in JP-A-2006-128874, since a network-connected apparatus is connected to a network by using a fixed IP address, the network-connected apparatus is likely to disturb communication performed by any one of the other apparatuses connected to the network, which competes with the network-connected apparatus, that is, which has an IP address the same as the IP address of the network-connected apparatus.

### SUMMARY

An advantage of some aspects of the invention is to provide a technology which enables a network-connected apparatus that is connected to a network to properly perform communication on the network without exerting any undesirable effects on communications performed by the other network-connected apparatuses that are connected to the network.

A network-connected apparatus according to a first aspect of the invention, which performs communication using an IP address via a network connected to the network-connected apparatus, and has a fixed first IP address having been set as an own IP address used for communication performed by the network-connected apparatus, includes a detection section configured to detect that the network-connected apparatus has been connected to a network, an IP address acquisition section configured to, upon detection of that the network-connected apparatus has been connected to a network, not perform communication using the first IP address, but acquire a second IP address, which is not used by any one of the other apparatuses existing on the network, by using an own MAC address of the network-connected apparatus, and an IP address setting section configured to set the second IP address as the own IP address used for communication performed by the network-connected apparatus. The network-connected apparatus according to this first aspect of the invention is configured to, when the network-connected apparatus having the fixed first IP address set thereon has been connected to a network, be capable of performing communication by using the second IP address, which is not used by any one of the other apparatuses existing on the network. Therefore, when the network-connected apparatus has been connected to a different network, the network-connected apparatus never disturbs communications performed by the other apparatuses connected to the different network.

Further, the above-described network-connected apparatus may further include a first IP address storage section configured to, upon detection of that the network-connected apparatus has been connected to a network, save and store the first IP address therein, and a setting determination section configured to set the second IP address as the own IP address of the network-connected apparatus, send an inquiry packet destined to the first IP address to the network, and on the basis of a result of having sent the inquiry packet, determine whether any other apparatus having the first IP address set thereon exists on the network, or not. Further, if it is determined that any other apparatus having the first IP address set thereon does not exist on the network, the IP address setting section may set the first IP address as the own IP address used for communication performed by the network-connected apparatus. The network-connected apparatus according to this aspect is configured to, if any other apparatus having the first IP address set thereon does not exist on the network, make the first fixed IP address be the own IP address used for communication performed by the network-connected apparatus. Therefore, for example, when having been reconnected to the same network as that over which the network-connected apparatus had previously been performing communication using a fixed IP address, the network-connected apparatus can use the fixed IP address as it is. Thus, the network-connected apparatus can appropriately maintain a communication environment to be applied when having been connected to the same network.

Further, the above-described network-connected apparatus may further include a range acquisition section configured to, from a DHCP server connected to the network, acquire an IP address range including IP addresses the DHCP server is capable of allocating, and if the first IP address belongs to the IP address range, the IP address setting section may set an IP address other than the first IP address as the own IP address used for communication performed by the network-connected apparatus. Therefore, the network-connected apparatus according to this aspect can appropriately prevent duplication of an IP address that is allocated to one of the other apparatuses existing on the network by the DHCP server and the own IP address of the network-connected apparatus.

Further, in the above-described network-connected apparatus, if it is determined that any other apparatus having the first IP address set thereon exists on the network, the second IP address may be set as the own IP address used for communication performed by the network-connected apparatus. Therefore, when having been connected to a different network, the network-connected apparatus according to this aspect never disturbs communications performed by the other apparatuses connected to the different network.

Further, the above-described network-connected apparatus may further include an address change notification section configured to, if it is determined that any other apparatus having the first IP address set thereon exists on the network, notify any other apparatuses, which previously performed communication with the network-connected apparatus, that the own IP address used for communication performed by the network-connected apparatus has been changed to the second IP address. In the network-connected apparatus according to this aspect, it is possible to appropriately notify other apparatuses, which have previously performed communication with the network-connected apparatus, of the change of the IP address.

Further, the above-described network-connected apparatus may further include a presentation section configured to, if it is determined that any other apparatus having the first IP address set thereon exists on the network, present a display screen for allowing a user to input an IP address used for communication performed by the network-connected apparatus. Therefore, if the first IP address cannot be used, the network-connected apparatus according to this aspect can allow users to appropriately set an IP address.

Further, the above-described network-connected apparatus may further include a search section configured to search for one or more third IP addresses, each of which is an IP address adjacent to the first IP address and is not used by any one of the other apparatuses existing on the network, and the presentation section may display the one or more third IP addresses. Therefore, the network-connected apparatus according to this aspect can allow users to appropriately figure out a usable IP address.

Further, in the above-described network-connected apparatus, the IP address setting section may be configured to, if it is determined that any other apparatus having the first IP address set thereon exists on the network, search for a fourth IP address, which is not used by any one of the other apparatuses existing on the network, and set the fourth IP address as the own IP address used for communication performed by the network-connected apparatus. Therefore, the network-connected apparatus according to this aspect can automatically set an IP address used for communication performed by the network-connected apparatus.

Further, in the above-described network-connected apparatus, the IP address acquisition section may acquire the second IP address from a DHCP server connected to the network. Therefore, the network-connected apparatus according to this aspect can easily and appropriately acquire an IP address that is not used by any one of the other apparatuses existing on the network from the DHCP server.

Further, in the above-described network-connected apparatus, the IP address acquisition section may be configured to search for a link local address, which is not used by any one of the other apparatuses existing on the network, from among link local addresses, and acquire the link local address, which is not used by any one of the other apparatuses existing on the network, as the second IP address. Therefore, the network-connected apparatus according to this aspect searches for a link local address from among link local addresses, which are not IP addresses that are constantly used, and thus, can easily and appropriately acquire an unused IP address.

A network connection method according to a second aspect of the invention, which is performed by a network-connected apparatus performing communication using an IP address via a network connected to the network-connected apparatus, and having a fixed first IP address having been set as an own IP address used for communication performed by the network-connected apparatus, includes the steps of detecting that the network-connected apparatus has been connected to a network in processing performed by a detection section of the network-connected apparatus, not performing communication using the first IP address but, by using an own MAC address of the network-connected apparatus, acquiring a second IP address, which is not used by any one of the other apparatuses existing on the network, when it has been detected that the network-connected apparatus has been connected to a network, in processing performed by an IP address acquisition section of the network-connected apparatus, and setting the second IP address as the own IP address used for communication performed by the network-connected apparatus in processing performed by an IP address setting section of the network-connected apparatus. Therefore, when the network-connected apparatus having a fixed first IP address set thereon has been connected to a network, the network connection method according to the second aspect enables communication using the second IP address that is not used by any one of the other apparatuses existing on the network. Thus, when the network-connected apparatus has been connected to a different network, the network-connected apparatus never disturbs communications performed by the other apparatuses connected to the different network.

### BRIEF DESCRIPTION OF THE DRAWINGS

The invention will be described with reference to the accompanying drawings, wherein like numbers reference like elements.

FIG. 1 is a diagram illustrating an example of a network system to which network-connected apparatuses according to an embodiment of the invention are connected.

FIG. 2 is a diagram illustrating a configuration of functions included in a network-connected apparatus according to an embodiment of the invention.

FIG. 3 is a flowchart illustrating network connection processing according to an embodiment of the invention.

### DESCRIPTION OF EXEMPLARY EMBODIMENTS

An embodiment according to the invention will be described hereinafter with reference to drawings. In addition, the invention is not limited to an embodiment which will be described hereinafter, and all of individual components and all of combinations thereof which will be described therein are not essential to means for solving problems in the invention.

Firstly, a network system having a printer connected thereto, which is provided as an example of a network-connected apparatus according to an embodiment of the invention, will be described below.

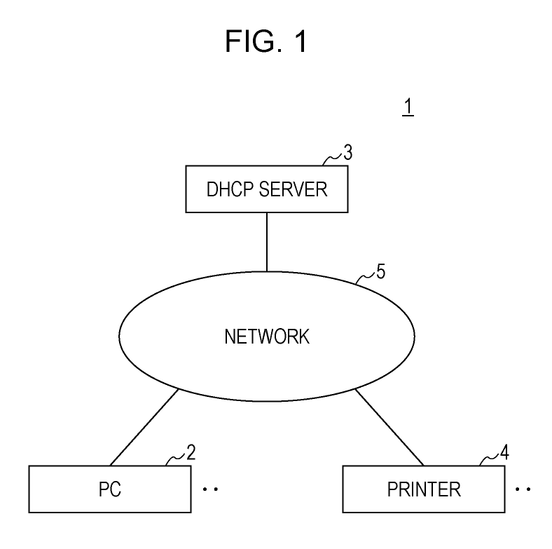

FIG. 1 is a diagram illustrating an example of a network system to which network-connected apparatuses according to an embodiment of the invention are connected.

A network system 1 shown in FIG. 1 is configured to include one or more personal computers (PCs) 2, a dynamic host configuration protocol (DHCP) server 3, and one or more printers 4. In addition, in some network systems, the DHCP server 3 is not included. The PC 2, the DHCP server 3 and the printer 4 are each configured to be arbitrarily connected and disconnected to/from the network 5. The network may be configured to include a wired communication link and/or a wireless communication link, as well as the Internet. The DHCP server 3 is configured to, in order to connect the PC 2 and/or the printer 4 to the network 5, allocate information necessary for the connection (for example, an IP address) thereto.

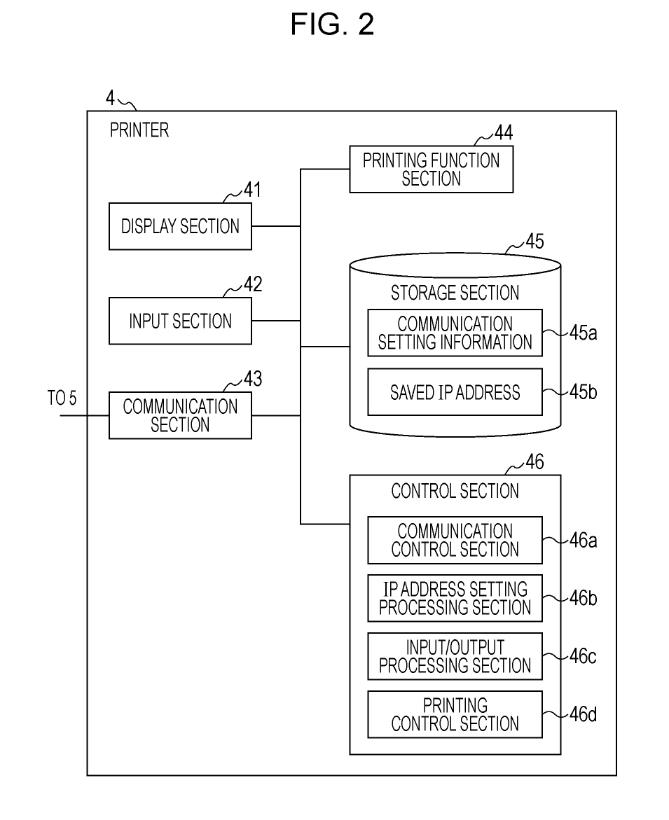

FIG. 2 is a diagram illustrating a configuration of functions included in a printer, which is provided as an example of a network-connected apparatus according to an embodiment of the invention.

The printer 4 is configured to include a display section 41, an input section 42, a communication section 43, a printing function section 44, a storage section 45 and a control section 46.

The display section 41 is configured to include, for example, a liquid crystal display screen and the like, and displays various information thereon. The input section 42 is configured to include, for example, a key operating unit, a touch panel unit and the like, and receives inputs, such as various directions from users. For example, the input section 42 receives, for example, directions relating to an IP address to be set on the printer, and the like. The communication section 43 performs transmitting and receiving to/from other apparatuses via the network 5. In this embodiment, the communication section 43 is configured to, when performing communication with other apparatuses existing on an IP network, perform communication using an IP address having been set on the printer 4 as an own IP address of the printer 4. The printing function section 44 forms (prints) images on various image forming media, such as a sheet of paper and an OHP sheet.

The storage section 45 is configured by, for example, a hard disc drive or EEPROM chips, and stores various pieces of information therein. In this embodiment, the storage section 45 stores therein communication setting information 45a that determines an own IP address used for communication performed by the printer 4. In this embodiment, as the communication setting information 45a, information relating to an automatic setting, in which an IP address is acquired from the DHCP server 3 and is automatically set on the printer 4, and an IP address that is determined in advance (a fixed IP address, i.e., a first IP address) are stored therein. Further, the storage section 45 stores a saved fixed IP address 45b therein, which will be described below. Moreover, the storage section 45 is configured to, in the case of the automatic setting, stores therein an IP address having been automatically acquired (which is an IP address that is used as an own IP address for communication performed by the printer 4).

The control section 46 is configured to include a communication control section 46a, which is provided as an example of a detection section and an IP address acquisition section, an IP address setting processing section 46b, which is provided as an example of an IP address setting section and a setting determination section, an input/output processing section 46c, which is provided as an example of a presentation section, and a printing control section 46d. The communication control section 46a, the IP address setting processing section 46b, the input/output processing section 46c and the printing control section 46d are each configured by causing a central processing unit (CPU), which is provided as an example of the control section 46, to execute programs stored in ROM chips and the like, which are omitted from illustration.

The communication control section 46a causes the communication section 43 to perform communication over the network 5, using an IP address having been set by the IP address setting processing section 46b. Further, the communication control section 46a detects whether the communication section 43 of the printer 4 has been connected to a network, or not, and upon detection of the connection to the network, the communication control section 46a notifies the IP address setting processing section 46b of the connection. Here, the above-described expression: “the printer 4 has been connected to a network” means that the printer 4, which is already physically connected to a network, has been powered on, a communication cable extending from a network has been newly connected to the printer 4 that is already powered on, the printer 4 has been connected to an access point via a wireless communication link, or the like. The communication control section 46a is configured to, in the case where an automatic IP address acquisition mode is set, acquire an IP address (a second IP address), which is not used by any one of the other apparatuses existing on a network to which the printer 4 has just been connected, by using a media access control address (a MAC address). More specifically, in the case where the DHCP server 3 is connected to the network, the communication control section 46a causes the communication section 43 to transmit a broadcasting packet having an own MAC address of the communication control section 46a appended thereto, and acquires an IP address, which is not used by any one of the other apparatuses existing on the network, from the DHCP server 3. Further, in the case where the DHCP server 3 is not connected to the network (i.e., in the case where no response to the above-described broadcasting packet is received), the communication control section 46a acquires an IP address by specifying an IP address, which is not used by any one of the other apparatuses existing on the network, from a range including link local addresses (for example, 169.254.0.0/16 in the case of IPv4). More specifically, the communication control section 46a specifies and acquires an unused IP address by selecting an IP address at random from a range including link local addresses, broadcasting a request for an address resolution protocol (ARP) by using the MAC address, and determining whether the selected IP address is already used, or not, on the basis of responses to the request.

Upon receipt of a notification notifying that the printer 4 has just been connected to a network, the IP address setting processing section 46b saves and stores the fixed IP address in the storage section 45, and sets a communication setting mode, which is a basis of processing performed by the communication control section 46a, to an automatic IP address acquisition mode.

The IP address setting processing section 46b sets the usable IP address (the second IP address), which has been acquired by the communication control section 46a, as an own IP address used for communication performed by the printer 4. Owing to this processing, as a result, the communication control section 46a uses the own IP address as an IP address for a communication originator.

Further, in the case where there exists a fixed IP address having been saved, the IP address setting processing section 46b causes the communication control section 46a to determine whether any other apparatus using the same fixed IP address exists on the network, or not, that is, whether the fixed IP address competes with any one of the other IP addresses that are used by respective apparatuses existing on the network, or not. For example, the IP address setting processing section 46b determines whether any other apparatus using the same fixed IP address exists on the network, or not, by executing a ping command to cause the communication control section 46a to transmit a packet destined to the fixed IP address to the network, and determining whether any response to the transmitted packet is received, or not. In addition, if there exists any other apparatus using the same fixed IP address, as a result, a response to the above-described packet can be received.

Further, the IP address setting processing section 46b is configured to, if the fixed IP address does not compete with any one of the other IP addresses used by respective apparatuses existing on the network, set the fixed IP address having been saved as an IP address used for communication performed by the communication control section 46a. In contrast, if the fixed IP address competes with any one of the other IP addresses used by respective apparatuses existing on the network, the IP address setting processing section 46b is configured to, if a currently used IP address is an IP address having been acquired from the DHCP server 3, maintain the currently used IP address as it is; in contrast, if a currently used IP address is not an IP address having been acquired from the DHCP server 3, that is, if the currently used IP address is a link local address, cause the input/output processing section 46c to execute IP address setting processing performed by a user, and set the IP address having been set by the user as an IP address used for communication performed by the communication control section 46a.

Upon receipt of various information from the input section 42, which are inputted by users, the input/output processing section 46c transfers the inputted information to the IP address setting processing section 46b and the like. In this embodiment, the input/output processing section 46c causes the display section 41 to display an input display screen for allowing an user to input an IP address, receives an IP address, which has been inputted by the user and is to be set on the printer 4, and transfers the inputted IP address to the IP address setting processing section 46b. The printing control section 46d receives printing data via the communication section 43, and on the basis of the received printing data, performs control so as to cause the printing function section 44 to form images on an image forming medium.

Next, processing operations performed by a network-connected apparatus according to an embodiment of the invention will be described below.

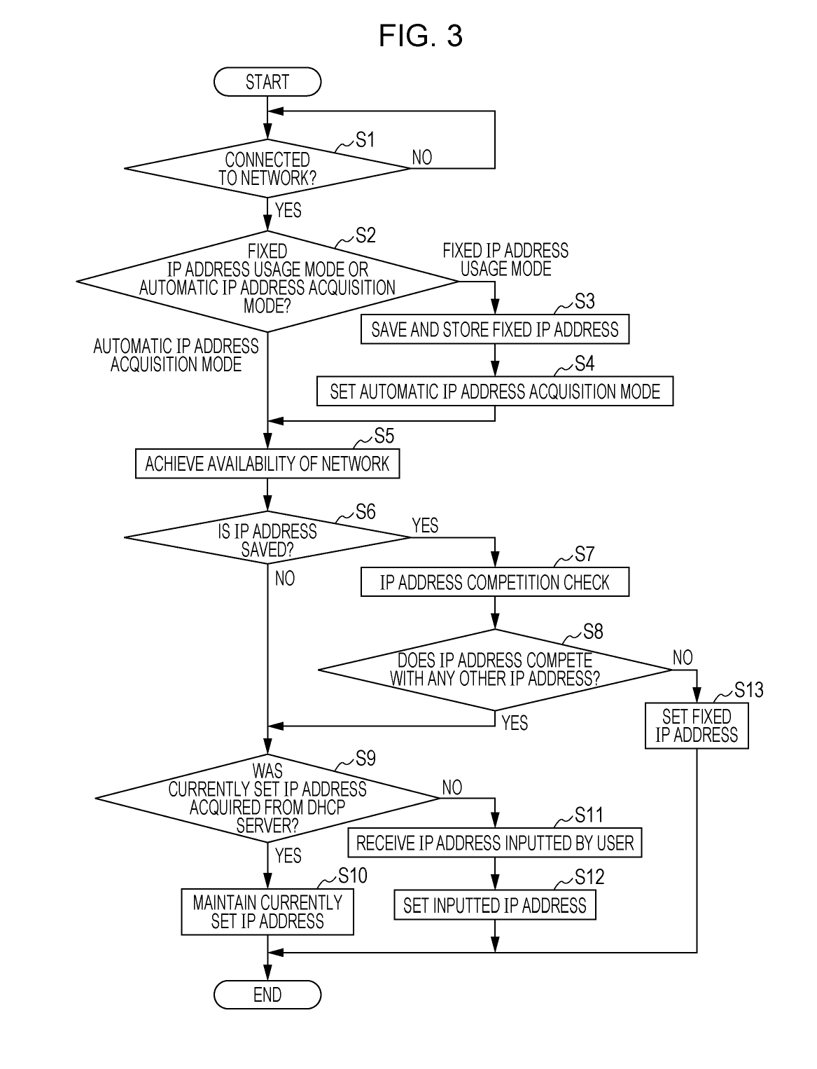

FIG. 3 is a flowchart illustrating network connection processing according to an embodiment of the invention.

Firstly, the communication control section 46a detects whether the communication section 43 of the printer 4 has been connected to a network, or not (step 1), and upon detection of that the communication section 43 has just been connected to a network connected (step S1: YES), the communication control unit 46a notifies the IP address setting processing section 46b of the connection.

Upon receipt of the notification from the communication control section 46a, which notifies that the printer 4 has just been connected to a network, the IP address setting processing section 46b determines whether either of a fixed IP address usage mode or an automatic IP address acquisition mode is set as a communication setting mode (step S2), and if the fixed IP address usage mode is set as the communication setting mode (step S2: fixed IP address usage mode), the IP address setting processing section 46b saves and stores a fixed IP address in the storage section 45 (step S3), and sets a communication setting mode, which is a basis of processing performed by the communication control section 46a, to an automatic IP address acquisition mode (step S4).

In contrast, if the automatic IP address acquisition mode is set as the communication setting mode (step 2: automatic IP address acquisition mode), or if the automatic IP address acquisition mode has been set as the communication setting mode in step 4, the communication control section 46a and the IP address setting processing section 46b perform the following processing for achieving availability of the network (step S5). That is, the communication control section 46a acquires an IP address (a second IP address), which is not used by any one of the other apparatuses existing on the network, which has just been connected to the communication section 43 of the printer 4, by using a packet having a media access control address (a MAC address) appended thereto. Further, if the DHCP server 3 is not connected to the network (i.e., if no response to the above-described packet is not received), the communication control section 46a acquires an IP address by specifying an unused IP address from a range including link local addresses. Further, the IP address setting processing section 46b sets the usable IP address (the second IP address) having been acquired by the communication control section 46a as an own IP address used for communication performed by the printer 4.

Subsequently, the IP address setting processing section 46b determines whether there is a saved fixed IP address, or not (step S6), and if there is a saved fixed IP address (step 6: YES), the IP address setting processing section 46b determines whether any other apparatus using the same fixed IP address exists on the network, or not, that is, whether the fixed IP address competes with any one of the other IP addresses used by respective apparatuses existing on the network, or not (steps S7 and S8).

As a result of such processes, if the fixed IP address competes with any one of the other IP addresses used by respective apparatuses existing on the network (step S8: YES), the IP address setting processing section 46b determines whether a currently used IP address is an IP address having been acquired from the DHCP server, or not (step S9), and if the currently used IP address is an IP address having been acquired from the DHCP server (step S9: YES), the IP address setting processing section 46b maintains the currently used IP address as it is, as the own IP address used for communication performed by the printer 4 (step S10).

In contrast, if the currently used IP address is not an IP address having been acquired from the DHCP server (step S9: NO), that is, if the currently used IP address is an link local address, the IP address setting processing section 46b receives an IP address that is obtained by causing the input/output processing section 46c to receive inputs from a user (step S11), and sets the IP address having been inputted by the user as the own IP address used for communication performed by the printer 4 (step S12).

In contrast, the fixed IP address does not compete with any one of the other IP addresses used by respective apparatuses existing on the network (step S8: NO), the IP address setting processing section 46b sets the saved fixed IP address as the own IP address used for communication performed by the printer 4 (step S13), and terminates the process flow. In this way, it is possible to appropriately return the own address used for communication performed by the printer 4 to the initially set fixed IP address. Therefore, for example, when the printer 4 has been reconnected to the same network as that on which the printer 4 had previously performed communication using the same fixed IP address, the printer 4 can continue communicating with other apparatuses, with which the printer 4 had previously performed communication over the network, without any troubles.

Hereinbefore, the invention has been described on the basis of the embodiment; however, the invention is not limited to the above-described embodiment, but can be applied to other various embodiments.

For example, in the above-described embodiment, processing is performed so that a fixed IP address is saved in advance, and if the fixed IP address does not compete with any one of the other IP addresses used by respective apparatuses existing on the network, the IP address used for communication performed by the printer 4 is returned to the initially set fixed IP address; however, the invention is not limited to this embodiment, but the IP address used for communication performed by the printer 4 may not be returned to the initially set fixed IP address. For example, if a fixed IP address does not compete with any one of the other IP addresses, the IP address setting processing section 46b (which is an example of a range acquisition section) acquires a range including IP addresses the DHCP server can allocate, determines whether the fixed IP address belongs to the range including IP addresses the DHCP server can allocate, or not, and if the fixed IP address belongs to the range including IP addresses the DHCP server can allocate, since an IP address the same as the fixed IP address is likely to be allocated to a different apparatus existing on the network by the DHCP server, the IP address used for communication performed by the printer 4 may not be returned to the fixed IP address, but the IP address, having been acquired from the DHCP server and being currently set as the IP address used for communication performed by the printer 4, may be used as it is.

Further, in the above-described embodiment, processing may be performed so that IP addresses of respective other apparatuses, with which the printer 4 has ever established communication, are stored in, for example, the storage section 45, and when an IP address of the printer 4 is changed to an IP address different therefrom, the IP address setting processing section 46b (which is an example of an address change notification section) notifies other apparatuses, with which the printer 4 has ever established communication, of a post-change IP address of the printer 4 by using the saved IP addresses.

Further, in the above-described embodiment, processing is performed so that an IP address to be used is inputted by a user, but the processing may be performed so that, when an IP address is inputted by a user, the IP address setting processing section 46b (which is an example of a search section) searches for an IP address, which is an IP address adjacent to the fixed IP address (for example, an IP address resulting from changing only the lowest-order bit or low-order several bits of the fixed IP address), and is not used by any one of the other apparatuses existing on the network (i.e., a third IP address), and the input/output processing section 46c causes the display section 41 to display and indicate the IP address having been searched for thereby to the user. Such a way as described above enables users to properly figure out and set an IP address, which is adjacent to the fixed IP address and is settable.

Further, in the above-described embodiment, processing is performed so that an IP address to be set is inputted by a user; however, the invention is not limited to this processing, but the processing may be performed so that the IP address setting processing section 46b searches for unused IP addresses (each of which is a fourth IP address), and automatically selects and sets an IP address from among the unused IP addresses.

Further, in the above-described embodiment, a printer has been described as an example of a network-connected apparatus; however, the network-connected apparatus is not limited to the printer, but, may be, for example, a personal computer, and after all, may be any apparatus that is capable of being connected to a network.

The entire disclosure of Japanese Patent Application No. 2009-279343, filed Dec. 9, 2009 is expressly incorporated by reference herein.

What is claimed is:

1. A network-connected apparatus, performing communication using an IP address via a network connected to the network-connected apparatus, and having a fixed first IP address having been set as an own IP address used for communication performed by the network-connected apparatus, the network-connected apparatus comprising:
a detection section configured to detect that the network-connected apparatus has been connected to a network;
an IP address acquisition section configured to, upon detection of that the network-connected apparatus has been connected to a network, not perform communication using the first IP address, but acquire a second IP address, which is not used by any one of the other apparatuses existing on the network, by using an own MAC address of the network-connected apparatus; and
an IP address setting section configured to set the second IP address as the own IP address used for communication performed by the network-connected apparatus.

2. The network-connected apparatus according to claim 1, further comprising:
a first IP address storage section configured to, upon detection of that the network-connected apparatus has been connected to a network, save and store the first IP address therein; and
a setting determination section configured to set the second IP address as the own IP address of the network-connected apparatus, send an inquiry packet destined to the first IP address to the network, and on the basis of a result of having sent the inquiry packet, determine whether any other apparatus having the first IP address set thereon exists on the network, or not,
wherein, if it is determined that any other apparatus having the first IP address set thereon does not exist on the network, the IP address setting section sets the first IP address as the own IP address used for communication performed by the network-connected apparatus.

3. The network-connected apparatus according to claim 2, further comprising:
a range acquisition section configured to, from a DHCP server connected to the network, acquire an IP address range including IP addresses the DHCP server is capable of allocating,
wherein, if the first IP address belongs to the IP address range, the IP address setting section sets an IP address other than the first IP address as the own IP address used for communication performed by the network-connected apparatus.

4. The network-connected apparatus according to claim 1, wherein, if it is determined that any other apparatus having the first IP address set thereon exists on the network, the second IP address is set as the own IP address used for communication performed by the network-connected apparatus.

5. The network-connected apparatus according to claim 4, further comprising:
an address change notification section configured to, if it is determined that any other apparatus having the first IP address set thereon exists on the network, notify any other apparatuses, which previously performed communication with the network-connected apparatus, that the own IP address used for communication performed by the network-connected apparatus has been changed to the second IP address.

6. The network-connected apparatus according to claim 1, further comprising:
a presentation section configured to, if it is determined that any other apparatus having the first IP address set thereon exists on the network, present a display screen for allowing a user to input an IP address used for communication performed by the network-connected apparatus.

7. The network-connected apparatus according to claim 6, further comprising:
a search section configured to search for one or more third IP addresses, each of which is an IP address adjacent to the first IP address and is not used by any one of the other apparatuses existing on the network,
wherein the presentation section displays the one or more third IP addresses.

8. The network-connected apparatus according to claim 1, wherein the IP address setting section is configured to, if it is determined that any other apparatus having the first IP address set thereon exists on the network, search for a fourth IP address, which is not used by any one of the other apparatuses existing on the network, and set the fourth IP address as the own IP address used for communication performed by the network-connected apparatus.

9. The network-connected apparatus according to claim 1, wherein the IP address acquisition section acquires the second IP address from a DHCP server connected to the network.

10. The network-connected apparatus according to claim 1, wherein the IP address acquisition section is configured to search for a link local address, which is not used by any one of the other apparatuses existing on the network, from among link local addresses, and acquire the link local address, which is not used by any one of the other apparatuses existing on the network, as the second IP address.

11. A network connection method, which is performed by a network-connected apparatus performing communication using an IP address via a network connected to the network-connected apparatus, and having a fixed first IP address having been set as an own IP address used for communication performed by the network-connected apparatus, the network connection method comprising the steps of:
detecting that the network-connected apparatus has been connected to a network in processing performed by a detection section of the network-connected apparatus;
not performing communication using the first IP address but, by using an own MAC address of the network-connected apparatus, acquiring a second IP address, which is not used by any one of the other apparatuses existing on the network, when it has been detected that the network-connected apparatus has been connected to a network, in processing performed by an IP address acquisition section of the network-connected apparatus; and
setting the second IP address as the own IP address used for communication performed by the network-connected apparatus in processing performed by an IP address setting section of the network-connected apparatus.
